(19) United States
(12) Patent Application Publication
(10) Pub. No.: US 2026/0314782 A1
(43) Pub. Date: Oct. 15, 2026

(54) Expandable Portable Trolley-Style Storage Bag

(71) Applicant: Donghong ZHAO, Guangdong (CN)

(72) Inventor: Donghong ZHAO, Guangdong (CN)

(21) Appl. No.: 19/177,316

(22) Filed: Apr. 11, 2025

(51) Int. Cl. A45C 13/38; A45C 7/00; A45C 13/10; A45C 13/26; B62B 1/00; B62B 1/26

(52) U.S. Cl. CPC A45C 13/385; A45C 7/0077; A45C 13/1046; A45C 13/262; B62B 1/008; B62B 1/266; A45C 2013/267

(57) ABSTRACT

An expandable portable trolley-style storage bag consists of a trolley and a bag body. The trolley comprises a telescopic handle rod, a base pivotally connected to its bottom, and caster wheels installed on the lower part of the base. The bag body comprises an outer bag and an inner bag. The bottom surface of the outer bag is connected to the upper surface of the base, the inner side thereof is fixed to the telescopic handle rod and the bag body is provided with a carrying handle. The inner bag is connected to the outer bag at the bag opening, with the other end open and equipped with a fastener. This storage bag is compact and portable, doubling its storage capacity by flipping the inner bag outward. It combines the functions of a carrying bag and a trolley, suitable for daily shopping as well as short-distance travel luggage.

### TECHNICAL FIELD

The present invention relates to the field of storage, and particularly to an expandable portable trolley-style storage bag.

### BACKGROUND

Disposable shopping bags in large supermarkets require payment for use, and their disposal can easily cause environmental pollution due to non-degradability. With the increasing awareness of energy conservation and environmental protection, people generally bring their own handheld storage bags when shopping, typically made of materials such as canvas, cotton, non-woven fabric, or nylon.

The patent with a publication number of US20100084443A1 discloses a “Reusable shopping bag system”. This foldable shopping bag comprises a base, a four-sided body, handles attached to the body, and a storage pouch affixed to the outer surface of the front side. When not in use, it can be folded into the storage pouch, and multiple shopping bags can be carried or stored via a carrying case with a flap and fasteners. This foldable shopping bag has two main issues during shopping use: first, the storage pouch is designed compactly for portability, resulting in limited storage capacity; second, when carrying heavier items in the pouch, it tends to dig into the hands.

### SUMMARY

To address the shortcomings mentioned above, the present invention provides an expandable portable trolley-style storage bag.

To achieve this object, the present invention provides an expandable portable trolley-style storage bag, including a trolley and a bag body arranged on the trolley for storage. The trolley includes a telescopic handle rod and a base, the base is pivotally connected to a bottom of the telescopic handle rod, and caster wheels are installed on a lower part of the base. The bag body includes an outer bag and an inner bag, wherein a bottom surface of the outer bag is fixed to an upper surface of the base, an inner side thereof is fixed to the telescopic handle rod, and the outer bag is provided with a carrying handle. The inner bag is fixedly connected to the outer bag at a bag opening, the other end of the inner bag is an open end and is provided with a fastener.

The present invention further provides a multifunctional portable storage device, including a foldable frame assembly and a bag body assembly. The foldable frame assembly includes: a telescopic handle rod assembly with a longitudinal axis, including a first tubular member and a second tubular member slidably nested within the first tubular member; a base pivotally connected to the bottom of the telescopic handle rod assembly, configured to rotate between an unfolded position and a folded position. The bag body assembly includes: a main storage cavity fixedly connected to the base and a reversible expansion cavity nested within the main storage cavity, and the reversible expansion cavity is connected to the main storage cavity via a connecting member.

### BRIEF DESCRIPTION OF DRAWINGS

The drawings, which form part of this application, are included to provide a further understanding of the invention. The illustrative embodiments and the descriptions thereof are intended to explain the invention and do not constitute undue limitations. In the drawings:

FIG. 1 is a perspective view of an expandable portable trolley-style storage bag (in a carry bag mode);

FIG. 2 is a schematic diagram of the trolley portion in FIG. 1;

FIG. 3 is a perspective view of an expandable portable trolley-style storage bag (in a trolley mode);

FIG. 4 shows a perspective view of an expandable portable trolley-style storage bag (a stored state);

FIG. 5 shows a perspective view of an expandable portable trolley-style storage bag (a usage state I);

FIG. 6 shows a perspective view of an expandable portable trolley-style storage bag (a usage state II).

Reference signs: Trolley (1); Telescopic handle rod (11); Handle rod sheath (111); Handle rod (112); Base (12); Caster wheel (13); Support foot (14); Bag body (2); Outer bag (21); Carrying handle (211); Inner bag (22); Fastener (23).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

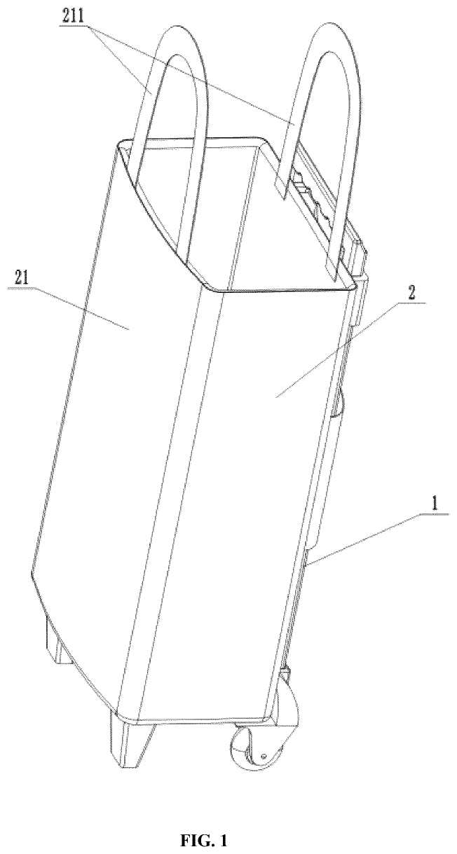

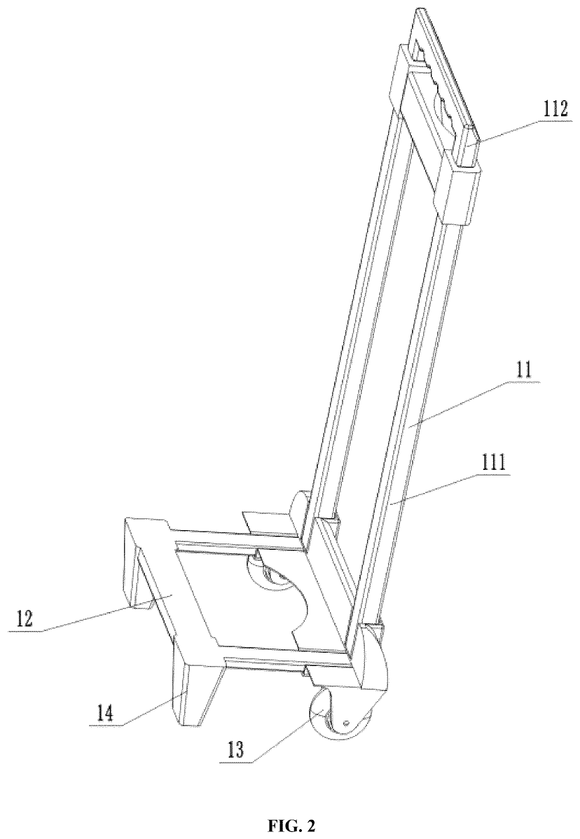

As shown in FIGS. 1 and 2, an expandable portable trolley-style storage bag according to an embodiment of the present invention includes a trolley 1 and a bag body 2 configured on the trolley 1 for storage. The trolley 1 comprises a telescopic handle rod 11 and a base 12. The base 12 is pivotally connected to the bottom of the telescopic handle rod 11 to enable folding and storage functionality. The trolley-style storage bag offers multiple functions, including a hand-carry mode, trolley mode, storage bag expansion mode, and storage mode, allowing users to perform different operations based on varying situations.

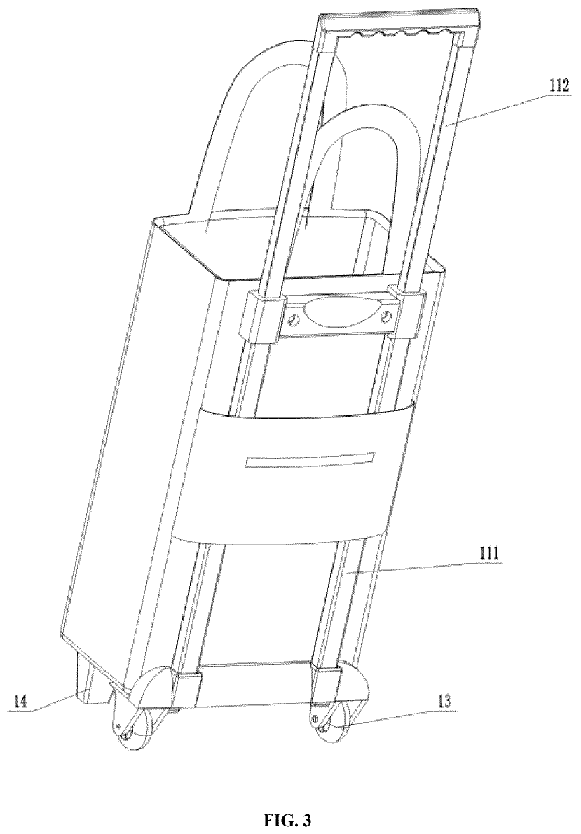

As shown in FIGS. 2, 3, and 4, in this embodiment, the telescopic handle rod 11 includes a handle rod 112 and a handle rod sheath 111. Taking the direction of the portable trolley-style storage bag in use (as shown in FIG. 3) as reference, the upper part is the handle rod 112, which is provide with a grip at its top for users to hold during use. The lower part is the handle rod sheath 111, which is used to connect to the base 12. Both the handle rod 112 and the handle rod sheath 111 are hollow rods. The cross-sectional size of the handle rod sheath 111 is larger than that of the handle rod 112, allowing the handle rod 112 to slide within the handle rod sheath 111. This enables a free sliding movement of the handle rod 112 inside the handle sheath 111 when the user holds the grip. The grip is also equipped with a unlock button. When the unlock button is not pressed, the handle rod 112 remains locked and cannot slide freely inside the handle rod sheath 111. When the unlock button is pressed, the handle rod 112 unlocks and can slide freely within the handle rod sheath 111. In other embodiments (not shown), the telescopic handle rod 11 may adopt a multi-section nested design, with an extension rod slidably installed between the handle rod 112 and the handle rod sheath 111. The handle rod 112 can then slide along the extension rod. This allows the handle rod to be adjusted to different lengths based on actual needs, accommodating users of varying heights.

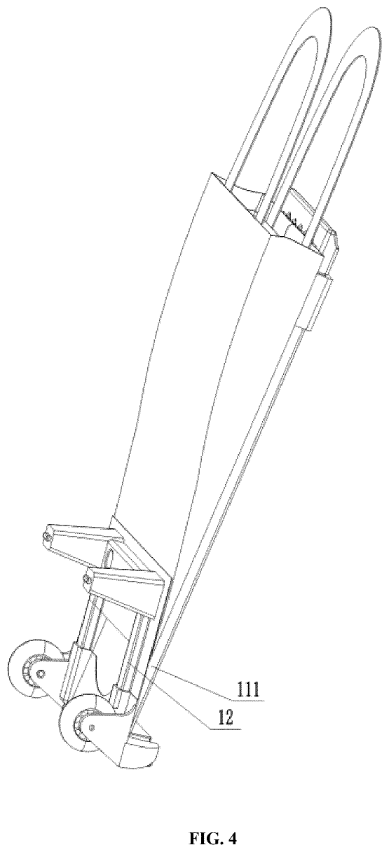

As shown in FIGS. 2 and 4, in this embodiment, the base 12 is rotatably connected to the bottom of the handle rod sheath 111, allowing the base 12 to rotate relative to the handle rod sheath 111, thereby enabling the base 12 to switch between a folded storage position and an unfolded use position. The lower part of the base 12 is equipped with caster wheels 13, with two wheels arranged symmetrically on the left and right. Both caster wheels 13 are straight-line wheels to ensure smooth movement in trolley mode. In other embodiments (not shown), the number of caster wheels 13 on the lower part of the base 12 can be increased to four, and they can be designed as universal wheels. This makes the trolley more maneuverable when in use, especially suitable for navigating crowded environments like supermarket aisles. Additionally, a braking mechanism can be installed on the wheels. When the trolley needs to be secured, stepping on the brake pedal locks the wheels, enhancing stability during use.

As shown in FIGS. 2 and 4, in this embodiment, the lower part of the base 12 is also equipped with two support feet 14. Together with the caster wheels 13, the support feet 14 provide stable ground contact for the base 12. The bottom surface of the support feet 14 is covered with anti-slip rubber pads to prevent slipping when placed on the ground. In other embodiments (not shown), the support feet 14 can be designed as telescopic structures. When used on uneven terrain, the height of the support feet 14 can be manually adjusted according to ground conditions, ensuring the base 12 remains level and the trolley stays stable.

As shown in FIGS. 1, 5, and 6, in this embodiment, the bag body 2 consists of two parts: an outer bag 21 and an inner bag 22. Both the outer bag 21 and inner bag 22 are made of flexible materials, allowing them to deform. The bottom surface of the outer bag 21 is fixed to the upper surface of the base 12, while the inner side of the outer bag 21 is fixed to the handle rod sheath 111 of the telescopic handle rod 11. The outer bag 21 is provided with a carrying handle 211, which is stitched to the outer bag 21 for users to lift the storage bag by the carrying handle when the bag is empty or lightly loaded. In other embodiments (not shown), the carrying handle 211 can be adjusted in length. For example, using a buckle similar to backpack straps, users can customize the length of the handle based on their preferences and needs. The carrying handle 211 with an adjustable length improves usability for individuals of different heights or when carrying the bag in different ways (e.g., single-hand or double-hand carry) in handheld mode.

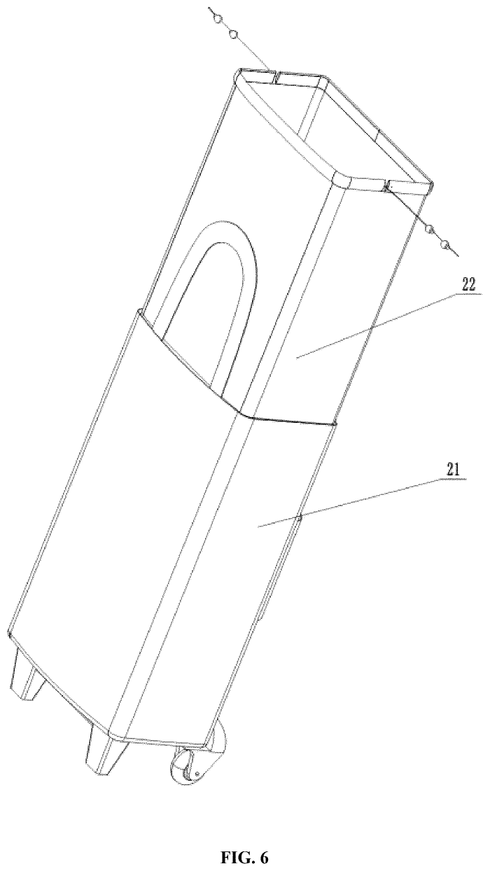

The inner bag 22 and the outer bag 21 are fixedly connected at the bag opening through stitching. During normal use, the inner bag 22 is placed inside the outer bag 21 and overlaps with it. When additional storage space is needed, the inner bag 22 can be turned inside out from the outer bag 21. After being fully turned out, the upper edge of the inner bag 22 is slightly higher than the extended handle rod 112 (see FIG. 6), doubling the storage space and maximizing storage capacity. In other embodiments (not shown), besides stitching as a fixed connection method, detachable structures such as zippers, hook-and-loop fasteners, buttons, or snap fasteners can be used to connect the outer bag 21 and inner bag 22. This allows the inner bag 22 to be detached from the outer bag 21 for separate cleaning or replacement when needed.

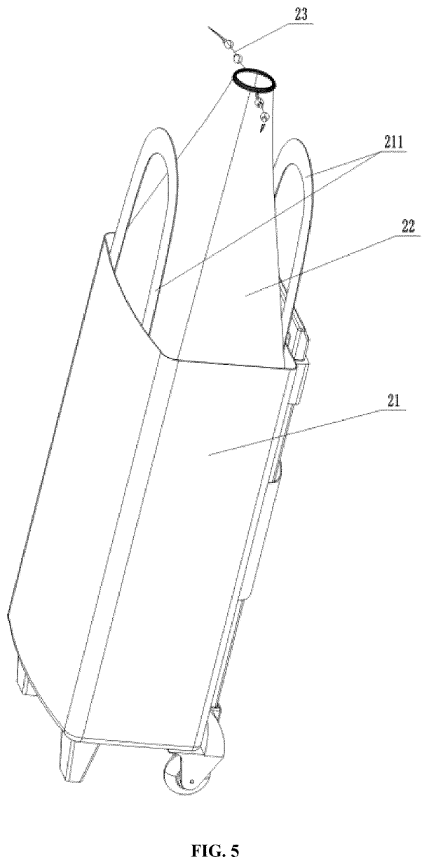

As shown in FIGS. 5 and 6, the other end of the inner bag 22 is an open end, which is equipped with a fastener 23 designed to tighten the open end of the inner bag 22, preventing items from spilling after the storage bag is expanded. In this embodiment, the fastener 23 includes two fastening cords arranged at the open end of the inner bag 22 and adjustment buckles threaded onto the fastening cords. Each fastening cord has two adjustment buckles: the first adjustment buckle is used to adjust the cord length by sliding the buckle along the cord, enabling the cord to tighten the open end of the inner bag 22 and prevent loosening due to trolley movement; the second adjustment buckle is used to secure the fastening cord to the handle rod 112, stabilizing the inner bag 22. When the storage bag is fully loaded, the inner bag 22 may tilt due to its height and flexibility after being turned out, causing instability. In this case, the fastening cord can be wrapped around the handle rod 112 and tightened with the second adjustment buckle to fix the inner bag 22 without tying knots, ensuring stability during use. Alternatively, a single fastening cord with two adjustment buckles threaded from opposite ends can be used. After wrapping the cord around the handle rod 112, the buckles are slid to tighten and secure the inner bag 22. The adjustment buckles are spring-loaded snap buckles.

For specific use, to facilitate understanding of the present invention, refer to the accompanying drawings for description.

In FIG. 1, during daily shopping, users can utilize the storage bag as a conventional carrying bag. The inner bag remains overlapped with the outer bag, while the carrying handle 211 provides a comfortable lifting experience, suitable for transporting lightweight items. In FIG. 3, when heavier items are loaded or the user needs to move over a longer distance, the handle rod 112 can be extended to switch to trolley mode. Here, the trolley comes into play, leveraging the caster wheels 13 on the base 12 for smooth movement, effectively reducing hand strain. In FIG. 4, when the storage bag is not in use, the telescopic handle rod 11 can be retracted, and the pivoting connection between the base 12 and the telescopic handle rod 11 allows for compact folding, facilitating easy storage. In FIG. 5, when additional storage space is required, the user can flip the inner bag 22 out of the outer bag 21 to expand the storage capacity. If securing the expanded space is necessary to prevent items from falling out, the fastener 23 can be used to seal the opening of the inner bag. In FIG. 6, the inner bag 22 is flipped out of the outer bag 21, doubling the storage space. Here, the open top of the inner bag 22 is not tightened by the fastener 23, making it convenient to load items inside.

Additionally, after the inner bag 22 is flipped out of the outer bag 21 and filled with items, the upper edge of the inner bag 22 slightly exceeds the extended handle rod 112 in height, maximizing storage capacity. When the fastener 23 fully seals the top of the inner bag 22, its upper edge sits slightly below the extended handle rod 112. The fastener 23 consists of a fastening cord configured at the open end of the inner bag 22, along with a first adjustment buckle and a second adjustment buckle threaded onto the cord. By adjusting the effective length of the fastening cord via the first adjustment buckle, the open end of the inner bag 22 can be tightened. Once the fastening cord seals the inner bag 22, it can be tied to the extended handle rod 112, and then the second adjustment buckle is tightened to secure the inner bag 22. This eliminates the need for knotting the cord while ensuring stability during use. To unload items from the storage bag, it simply needs to slide the second adjustment buckle open to release the cord from the handle rod 112, then slide the first adjustment buckle open to loosen the open end of the inner bag 22 for item removal.

This storage bag features a compact and portable design, offering multiple functions such as carrying handle mode, trolley mode, expanded storage mode, and storage mode to meet users'needs in various scenarios. For instance, the carrying handle mode provides a comfortable lifting experience for daily shopping with lightweight items. When transporting heavier items or moving over longer distances, users can switch to trolley mode, utilizing the base caster wheels for smooth movement and reduced hand strain. To accommodate larger storage needs, the inner bag can be turned inside out to double the storage space, while the fastener at the open end of the inner bag, such as a fastening cord or zipper, allows users to choose the fastening function as needed to prevent spillage of items. When not in use, the bag can be compactly stored by retracting the telescopic handle rod and folding the base. This storage bag is suitable not only for daily shopping but also for short trips and luggage carrying.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. An expandable portable trolley-style storage bag, comprising a trolley and a bag body arranged on the trolley for storage, wherein the trolley comprises a telescopic handle rod and a base, the base is pivotally connected to a bottom of the telescopic handle rod, and caster wheels are installed on a lower part of the base ; and
the bag body comprises an outer bag and an inner bag, wherein a bottom surface of the outer bag is fixed to an upper surface of the base, an inner side thereof is fixed to the telescopic handle rod, and the outer bag is provided with a carrying handle ; and the inner bag is fixedly connected to the outer bag at a bag opening, the other end of the inner bag is an open end and is provided with a fastener.

2. The expandable portable trolley-style storage bag according to claim 1, wherein the telescopic handle rod comprises a handle rod sheath and a handle rod slidably installed within the handle rod sheath, wherein a top of the handle rod is provided with a grip, the grip is equipped with an unlock button, and when the unlock button is pressed, the handle rod is slidable freely, and the base is rotatably connected to the handle rod sheath.

3. The expandable portable trolley-style storage bag according to claim 1, wherein the inner bag and the outer bag are fixedly connected at the bag opening by stitching.

4. The expandable portable trolley-style storage bag according to claim 3, wherein the fastener comprises a drawstring provided at the open end of the inner bag and an adjustment buckle threaded onto the drawstring.

5. The expandable portable trolley-style storage bag according to claim 4, wherein the fastening cord is threaded with a first adjustment buckle and a second adjustment buckle, wherein the first adjustment buckle is configured to adjust a length of the fastening cord to tighten the open end of the inner bag ; and the second adjustment buckle is configured to secure the inner bag by tightening the fastening cord when the fastening cord is tied to the handle rod.

6. The expandable portable trolley-style storage bag according to claim 1, wherein there are two caster wheels that are symmetrically arranged left and right, and the lower part of the base is further equipped with two support feet.

7. The expandable portable trolley-style storage bag according to claim 6, wherein a lower surface of the support foot is affixed with an anti-slip rubber pad.

8. An expandable portable trolley-style storage bag, comprising a trolley and a bag body, wherein the trolley comprises:
a telescopic handle rod, comprising a handle rod sheath and a handle rod, the handle rod being slidably mounted in the handle rod sheath ; and
a base pivotally connected to a bottom of the telescopic handle rod, the base being configured to rotate between an unfolded position and a folded position; and
the bag body comprises:
an outer bag fixedly connected to the base and an inner bag disposed inside the outer bag, the inner bag being connected to the outer bag via a connecting member, and the inner bag being able to turned inside out from the outer bag to expand a storage capacity of the bag.

9. The expandable portable trolley-style storage bag according to claim 8, wherein the connecting member is a detachable connection structure, and the inner bag is detachably connected to an opening position of the outer bag via the detachable connection structure.

10. The expandable portable trolley-style storage bag according to claim 8, wherein the inner bag is fixedly connected to the opening position of the outer bag by stitching.

11. The expandable portable trolley-style storage bag according to claim 8, wherein the outer bag is provided with a carrying handle, and the carrying handle is fixedly connected to the outer bag by stitching.

12. The expandable portable trolley-style storage bag according to claim 8, wherein the other end of the inner bag is an open end, and the open end is provided with a fastener.

13. The expandable portable trolley-style storage bag according to claim 12, wherein the fastener comprises a fastening cord arranged at the open end of the inner bag and an adjustment buckle threaded on the fastening cord.

14. The expandable portable trolley-style storage bag according to claim 13, wherein the fastening cord is threaded with a first adjustment buckle and a second adjustment buckle, wherein the first adjustment buckle is configured to adjust a length of the fastening cord to tighten the open end of the inner bag; and the second adjustment buckle is configured to secure the inner bag by tightening the fastening cord when the fastening cord is tied to the handle rod.

15. The expandable portable trolley-style storage bag according to claim 8, wherein the lower part of the base is equipped with caster wheels, there are two caster wheels, symmetrically arranged left and right, and the lower part of the base is also equipped with two support feet.

16. The expandable portable trolley-style storage bag according to claim 15, wherein a lower surface of the support foot is affixed with an anti-slip rubber pad.

17. The expandable portable trolley-style storage bag according to claim 8, wherein a top of the handle rod is provided with a grip, the grip is equipped with an unlock button, and when the unlock button is pressed, the handle rod is slidable freely.

18. The expandable portable trolley-style storage bag according to claim 8, wherein the base is rotatably connected to the handle rod sheath.
